(19) United States
(12) Patent Application Publication
(10) Pub. No.: US 2026/0298347 A1
(43) Pub. Date: Oct. 1, 2026

(54) VALVE FOR APPARATUS INCLUDING A LIFTING DEVICE

(71) Applicant: Harbor Freight Tools USA, INC., Calabasas, CA (US)

(72) Inventor: Andrew McGraw, Newbury Park, CA (US)

(21) Appl. No.: 19/092,132

(22) Filed: Mar. 27, 2025

(51) Int. Cl. F16K 1/14; B66F 3/25; F16K 1/02; F16K 1/32

(52) U.S. Cl. CPC F16K 1/14; B66F 3/25; F16K 1/02; F16K 1/32

(57) ABSTRACT

According to embodiments, a valve in a lifting device is configured to operate in a metering mode and in a shutoff mode to control fluid through an orifice, the valve comprising: a poppet; a first portion (e.g., a screw or a piston head) configured to move in a first direction forcing the poppet to seal the orifice in the shutoff mode, and further configured to move in a second direction releasing the poppet from the orifice in the metering mode; and a second portion (e.g., a spring, such as a plurality of Belleville washers) configured to regulate positioning of the poppet with respect to the orifice in the metering mode. The first portion may be not compressible, and wherein the second portion may be compressible. A flow rate of the fluid may be adjustable corresponding to an adjustable position of the first portion.

### CROSS-REFERENCE TO RELATED APPLICATIONS

Not Applicable

### BACKGROUND

The present disclosure relates generally to valves in lifting devices or presses. Such lifting devices or presses include hydraulic jacks, pneumatic jacks, air hydraulic jacks, hand-operated jacks, and presses (e.g., a shop press, such as an H-frame shop press). One type of a lifting device is a floor jack. Other types of lifting devices include bottle jacks or those utilizing bottle jacks (e.g., lifting devices for ATVs, motorcycles, mowers, transmissions, or the like). Another type of lifting device is a trolley jack.

Such valves include descent valves or release valves.

### SUMMARY

A valve for an apparatus that includes a jack is disclosed, substantially as illustrated by and described in connection with at least one of the figures and as set forth in the claims. In the exemplary embodiments, a hydraulic floor jack is disclosed with a descent valve, although the scope of this disclosure is not so limited. As will be understood, certain embodiments may be applicable to other types of lifting devices or jacks, including pneumatic jacks or air hydraulic jacks, or apparatuses including such jacks. Certain embodiments may be applicable to other types of apparatuses aside from a floor jack, such a shop press. Certain embodiments may be applicable to other types of valves in addition to descent valves, such as release valves.

According to embodiments, a valve in a lifting device is configured to operate in a metering mode and in a shutoff mode to control fluid through an orifice, the valve comprising: a poppet; a first portion (e.g., a screw or a piston head) configured to move in a first direction forcing the poppet to seal the orifice in the shutoff mode, and further configured to move in a second direction releasing the poppet from the orifice in the metering mode; and a second portion (e.g., a spring, such as a plurality of Belleville washers) configured to regulate positioning of the poppet with respect to the orifice in the metering mode. The first portion may be not compressible, and wherein the second portion may be compressible. A flow rate of the fluid may be adjustable corresponding to an adjustable position of the first portion.

According to embodiments, a lifting device includes: a cylinder configured to retain a fluid; a reservoir configured to receive fluid from the cylinder; and a valve configured to control the fluid flowing from the cylinder to the reservoir through an orifice, the valve comprising: a poppet; a first portion (e.g., a screw or a piston head) configured to move in a first direction forcing the poppet to seal the orifice in a shutoff mode, and further configured to move in a second direction releasing the poppet from the orifice in a metering mode; and a second portion (e.g., a spring or Belleville washer(s)) configured to regulate positioning of the poppet with respect to the orifice in the metering mode. The first portion may be not compressible, and wherein the second portion may be compressible. The flow rate of the fluid may be adjustable corresponding to an adjustable position of the first portion.

According to embodiments, a lifting device for supporting an object includes: a lifting arm configured to receive a load; a valve chamber configured to receive a valve; a cylinder configured to retain a fluid; a reservoir configured to receive the fluid from the cylinder; a cylinder passage extending between the cylinder and the valve chamber; a reservoir passage extending from the reservoir; and a plurality of valve chamber passages located between the valve chamber and the reservoir passage, wherein the valve controls the fluid flowing from the cylinder passage to the plurality of valve chamber passage.

### BRIEF DESCRIPTION OF SEVERAL VIEWS OF THE DRAWINGS

The following is a brief description of the drawings pertaining to the present disclosure, which will be discussed in more detail in the detailed description section below.

FIG. 1 illustrates a hydraulic floor jack.

FIG. 2A illustrates a valve in a portion of a hydraulic floor jack, according to embodiments.

FIG. 2B illustrates a flow diagram of fluid movement in a hydraulic floor jack, according to embodiments.

FIG. 3 illustrates a valve in a portion of a hydraulic floor jack, according to embodiments.

FIG. 4 illustrates a release valve port in a jack.

FIG. 5 illustrates an exploded view of a first descent valve for a jack, according to embodiments.

FIG. 6A illustrates a cross-sectional view of first descent valve in a release valve port in a jack in a shutoff mode, according to embodiments.

FIG. 6B illustrates a cross-sectional view of a first descent valve in a release valve port in a jack in a metering mode, according to embodiments.

FIG. 7A illustrates an exploded view of a second descent valve for a jack, according to embodiments.

FIG. 7B illustrates a cross-sectional view of a second descent valve in a release valve port in a jack in a shutoff mode, according to embodiments.

FIG. 7C illustrates a cross-sectional view of a second descent valve in a valve block in a jack in a metering mode, according to embodiments.

FIG. 8 illustrates an exploded view of a third descent valve for a jack, according to embodiments.

FIG. 9A illustrates a cross-sectional view of a third descent valve in a release valve port in a jack in a shutoff mode, according to embodiments.

FIG. 9B illustrates a cross-sectional view of a third descent valve in a valve block in a jack in a metering mode, according to embodiments.

FIG. 10A illustrates an exploded view of a fourth descent valve for a jack, according to embodiments.

FIG. 10B illustrates an exploded view of a compressible portion of a fourth descent valve for a jack, according to embodiments.

FIG. 11A illustrates a cross-sectional view of a fourth descent valve in a release valve port in a jack in a shutoff mode, according to embodiments.

FIG. 11B illustrates a cross-sectional view of a fourth descent valve in a valve block in a jack in a metering mode, according to embodiments.

FIG. 12 is a flowchart for a method of operation of a descent valve in a jack, according to embodiments.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein. Furthermore, the appearance shown in the drawings is one of many ornamental appearances that can be employed to achieve the stated functions of the system.

### DETAILED DESCRIPTION

Existing descent valves in lifting devices, jacks, or presses may be adjusted by an operator. Certain embodiments herein refer to a jack, but the techniques are applicable to other lifting devices or presses. The descent valve may have a screw or other tightening/loosening mechanism that allows the descent valve to be pushed into or pulled out of a chamber in the jack. The screw can be coupled to a handle that allows the operator to tighten/loosen the screw without an additional tool. The chamber is coupled with a passage from the cylinder of the jack and a passage from the reservoir of the jack via different orifices. When the operator loosens the screw, the cylinder passage and reservoir passage are in fluid communication with each other. In this way, fluid (e.g., oil) from the cylinder can flow to the reservoir as a result of the force exerted by the load (a supported object) on the fluid. A fluid may be either a liquid or a gas, or a combination thereof. When the operator fully tightens the screw, an orifice is blocked and the cylinder passage and the reservoir passage are no longer in fluid communication with each other, and fluid can no longer flow from the cylinder to the reservoir of the jack. The operator can fully tighten the screw to operate the jack in a lifting mode to lift a load (or object) supported by the jack. The operator can loosen the screw to operate the jack in a descent mode to lower the load.

When the screw is loosened, the flow of fluid from the cylinder to the reservoir can be unmetered or unregulated or such metering or regulation is difficult to achieve. A relatively small amount of release handle rotation, can cause an abrupt and faster-than-desired descent rate of the load. For example, when fluid flow begins, there may be an initial, rapid descent rate of the load on the jack (due to initial, rapid fluid flow). The flow rate of the fluid is substantially fixed per the screw position, either limited by the valve open area, or the small outlet orifice at the base of the cylinder. The descent may be more rapid than desired. Further, while the operator may be able to adjust the rate of fluid flow by carefully tightening or loosening the screw, the fluid flow can change rates by large amounts based on small amounts of tightening/loosening.

The valves disclosed herein may operate in a metering mode to substantially meter or regulate the flow of fluid from the loaded cylinder to the reservoir. Such metering or regulation may inhibit a rapid initial descent of a load supported by the jack by regulating the flow of fluid from the cylinder to the reservoir. The degree of metering or regulation for the valves disclosed herein may allow finer control of descent speed, as well as potentially limit maximum descent speed. Further, the valves disclosed herein may allow the operator to completely stop fluid flow by selectively placing a valve in a shutoff mode. Thus, the valves disclosed herein may operate in both a metering or regulated mode and a shutoff mode.

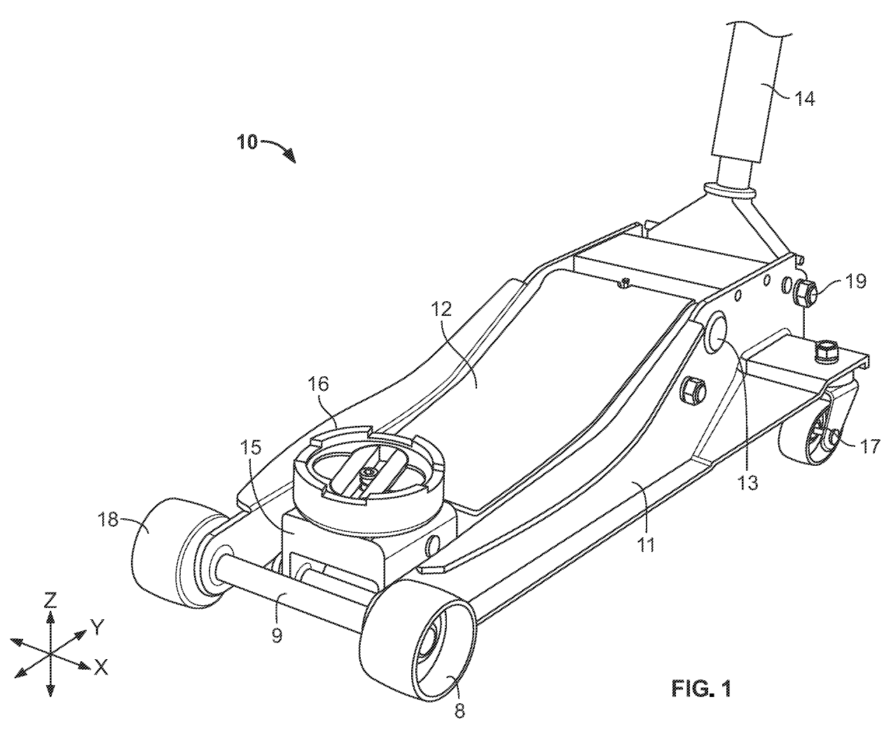

Referring to FIG. 1, a floor jack 10 is shown. The floor jack 10 includes a body 11, a lifting arm 12 pivotally connected to the body 11 at a lifting arm pivot 13. The floor jack 10 also includes a handle 14 operable to actuate rotation of the lifting arm 12 at the lifting arm pivot 13, thereby raising a saddle 16. The saddle 16 is coupled to the lifting arm 12 with a saddle mount 15. The handle 14 is operable to raise the lifting arm 12 by causing the lifting arm 12 to rotate about the lifting arm pivot 13. Such lifting may be achieved by an operator pumping the handle 14 up and down by rotating the handle 14 about a handle pivot 19. The handle 14 can be pumped multiple times to raise the saddle 16 incrementally. The handle 14 can further be rotated about the lengthwise axis of the handle 14 by the operator to lower the lifting arm 12. For example, the operator may rotate the handle 14 in a first direction, such as a counterclockwise direction, to control the lowering of the lifting arm 12. In alternative embodiments, the operator may rotate the handle 14 in an alternative direction, such as a clockwise direction, to control the lowering of the lifting arm 12. The amount of rotation applied to the handle 14 by the operator may control the rate of descent of the lifting arm 12. For example, the more rotation of the handle 14 applied by the operator will increase the rate at which the lifting arm 12 may be lowered towards the body 11 of the floor jack 10. At the rear of the floor jack 10 are two rotatable rear wheels 17 coupled to the body 11 for navigating the floor jack 10 in different directions. Optionally, the rear wheels 17 may be caster wheels, rigid axle wheels, or the floor jack 10 may be supported at the rear with a pair of track wheels. At the front of the floor jack 10 are two front wheels 18 coupled to the body 11. The front wheels 18 may be caster wheels, rigid axle wheels, or track wheels. Additionally, the rear wheels 17 and the front wheels 18 may be coupled to braking mechanisms to prohibit unwanted or undesired movement of the floor jack 10. The handle 14 is also operable to assist in positioning and maneuvering the floor jack 10 about a surface upon which the floor jack 10 rests.

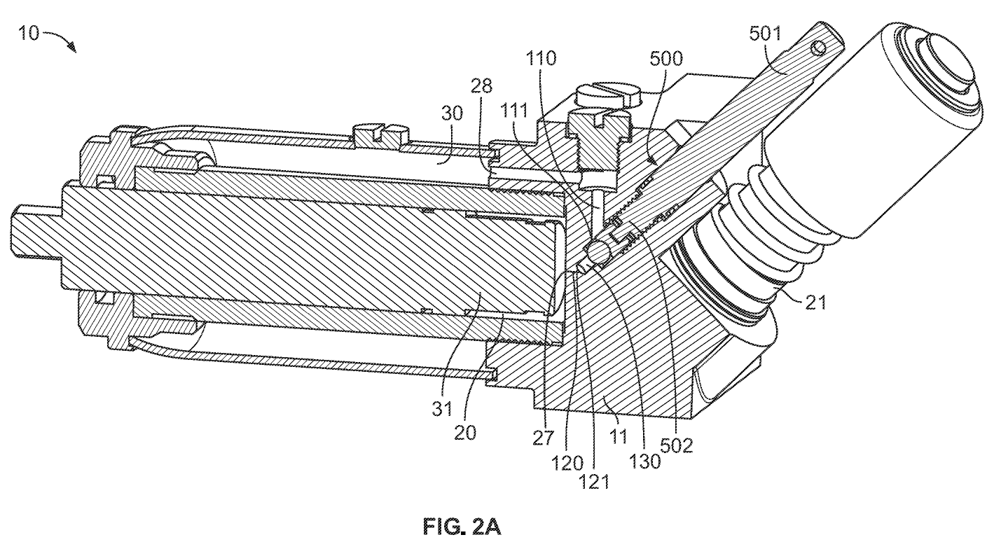

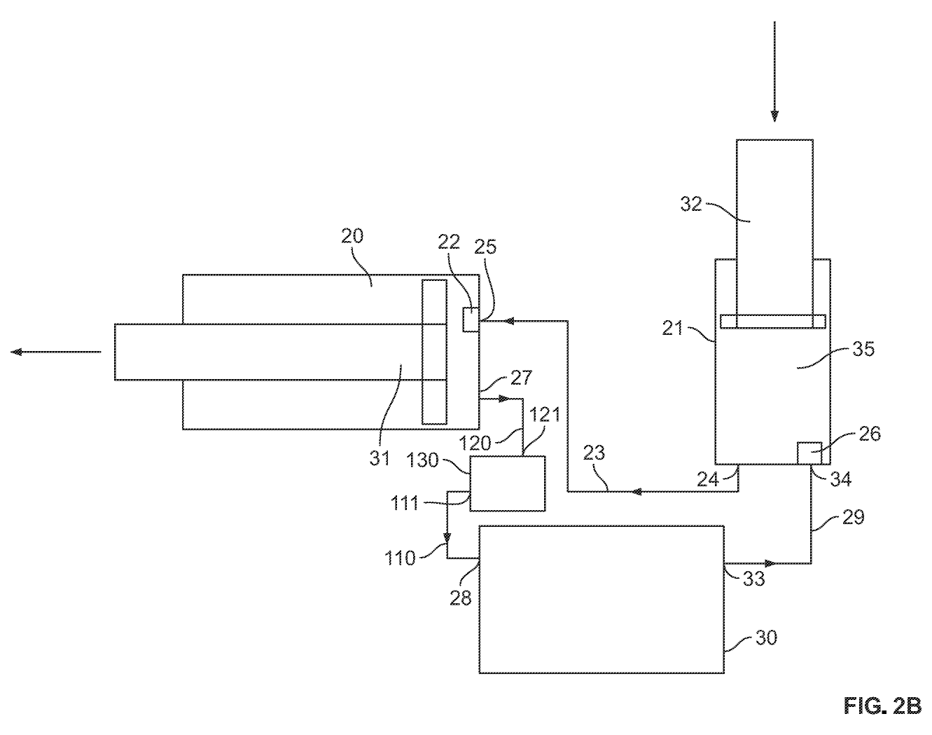

Referring to FIG. 2A, a partial view of the floor jack 10 is shown. The floor jack 10 includes at least one pump 21, a descent valve 500, a valve chamber 130, a reservoir passage 110, a reservoir 30, a cylinder passage 120, and a lift cylinder 20. In the exemplary embodiment, the floor jack 10 may have two pumps 21. In alternative embodiments, the floor jack 10 may only have one pump 21. The pump 21 as an internal volume 35, as shown, for example, in FIG. 2B. The descent valve 500 includes a handle portion 501 and a chamber portion 502. The handle portion 501 of the descent valve 500 may be received in a portion of the handle 14 located near the body 11 of the floor jack 10 (not shown). The chamber portion 502 may be received in the chamber 130 located in the body 11 of the floor jack 10. The operator may control the descent valve 500 by rotating the handle 14 about the longitudinal axis in either a first or second direction, such as counterclockwise or clockwise direction. The handle 14 is coupled to the descent valve 500, such that rotating the handle 14 causes movement of the descent valve 500 in the valve chamber 130. When the handle 14 is rotated in one direction, the descent valve 500 moves within the valve chamber 130 thereby permitting fluid to flow from the lift cylinder 20 to the reservoir 30. As fluid flows out of the lift cylinder 20, the lift piston 31 retracts and the lifting arm 12, the saddle 16, and the load descends due to gravity. Alternatively, the lifting arm 12 without a load on the saddle 16, the fluid flows out of the lift cylinder 20, the lift piston 31 retracts and the lifting arm 12 without a load descends due to combination of gravity and return springs. The reservoir passage 110 extends from the valve chamber 130 to the reservoir 30. The reservoir passage 110 permits fluid, such as hydraulic fluid, to flow between the reservoir 30 and the valve chamber 130. Fluid may exit the valve chamber 130 through a reservoir passage orifice 111 and flow through the reservoir passage 110 towards a first reservoir port 28 and to the reservoir 30. The cylinder passage 120 extends from the valve chamber 130 to the lift cylinder 20. The cylinder passage 120 permits fluid, such as hydraulic fluid, to flow between the lift cylinder 20 and the valve chamber 130. Fluid may exit the lift cylinder 20 through a second lift cylinder port 27 and flow through the cylinder passage 120 towards a cylinder passage orifice 121 and into the valve chamber 130. A lift piston 31 is located within the lift cylinder 20.

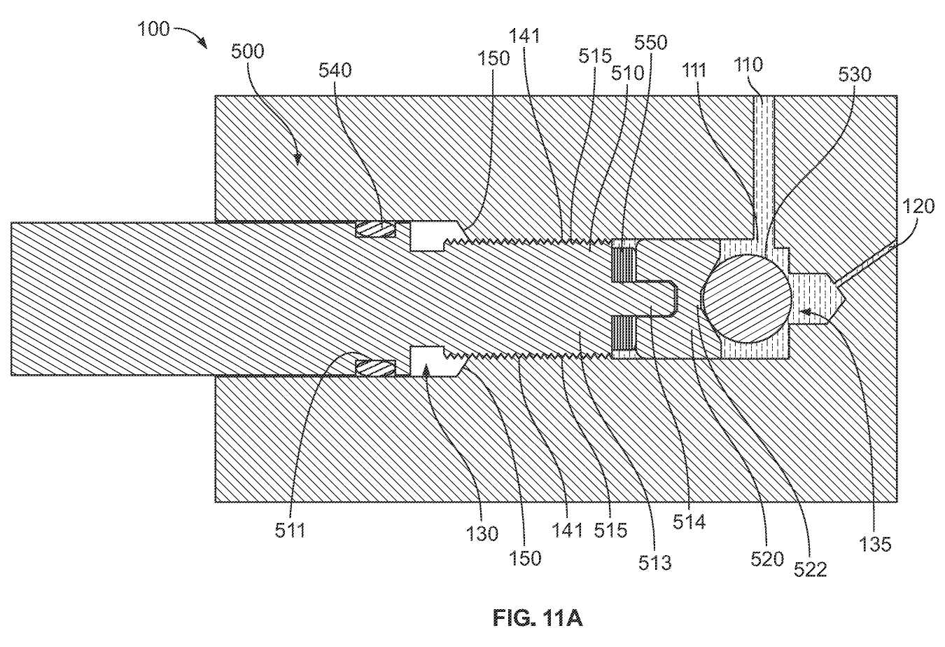

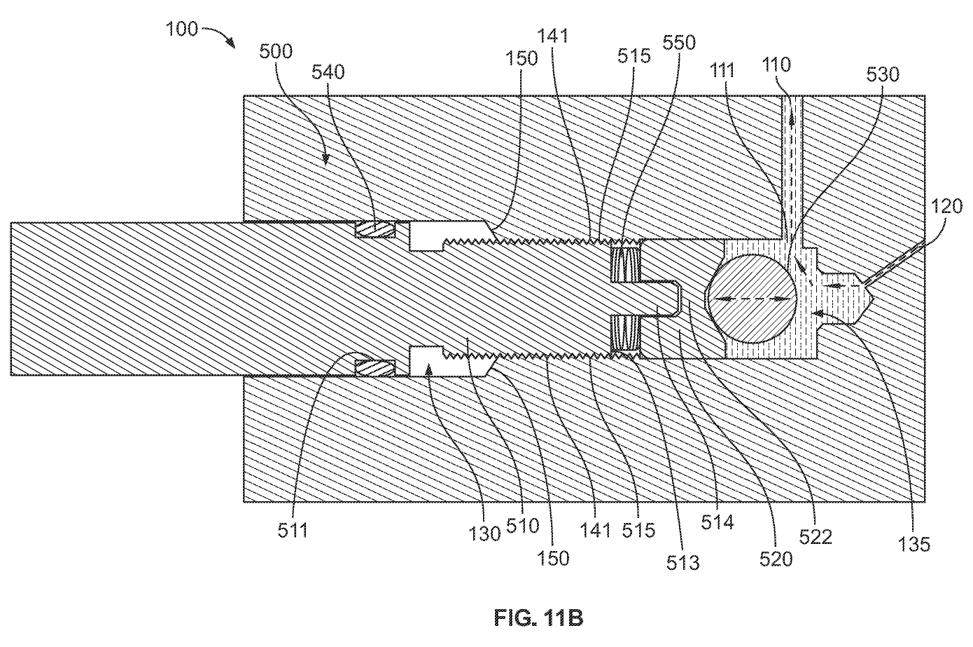

Referring to FIG. 2A, when the saddle 16, see FIG. 1, and optionally a load supported by the saddle 16 is raised, the force caused by the weight of the saddle 16, the load, and other components (e.g., the lifting arm 12) increases pressure on the fluid in the lift cylinder 20. When the descent valve 500 is closed, fluid is prevented from flowing from the lift cylinder 20 to the reservoir 30. The handle 14 (via twisting and untwisting as described above), see FIG. 1, is further operable to engage a descent valve 500 positioned in a release valve port 100 (shown in FIG. 11A) in the body 11.

Referring to FIG. 2B, the fluid pathway between the pump 21 and the lift cylinder 20 is shown. The handle 14 is moved about the handle pivot 19, see FIG. 1, to raise the lifting arm 12. The back-and-forth movement of the handle 14 about the handle pivot 19 causes the pump piston 32 to move in the pump 21 decreasing the internal volume 35 of the pump 21. The fluid located in the internal volume 35 of the pump 21 flows from the internal volume 35 and exits the pump 21 at the first pump port 24 and flows through the fluid conduit 23. The fluid conduit 23 extends between the pump 21 and the lift cylinder 20. The fluid exits the fluid conduit 23 and enters the pump 21 at the first lift cylinder port 25. A lift check valve 22 is located near the first lift cylinder port 25. As a result of the handle 14 being moved about the handle pivot 19, fluid may exit the pump 21 and enter the lift cylinder 20 causing the lift piston 31 to begin moving in a direction to cause the lift arm 12 to move in an upward direction. The more fluid pumped into the pump 21 through the first lift cylinder port 25 and the lift check valve 22, the more the lift piston 31 is moved in the direction to cause the lift arm 12 to move in the upward direction.

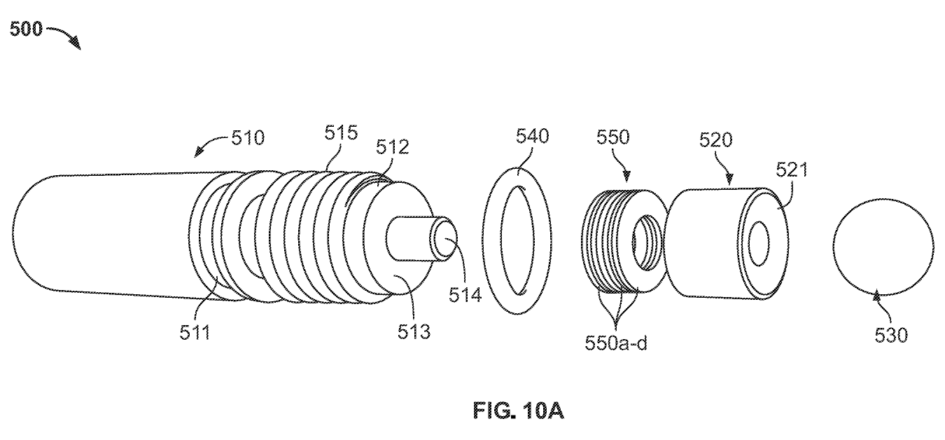

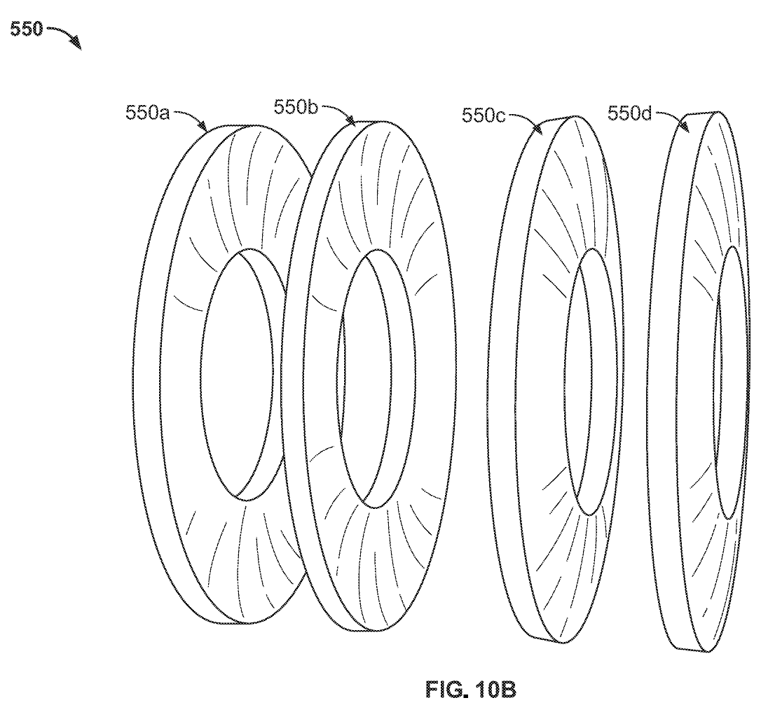

FIG. 2A further illustrates the descent valve 500 that meters the flow of hydraulic fluid from the lift cylinder 20 to the pump 21 when the saddle 16 descends. Descent valve 500 is further disclosed in FIGS. 10A-11B and corresponding text. Alternative embodiments of a descent valve 200, 300, 400 are also disclosed herein.

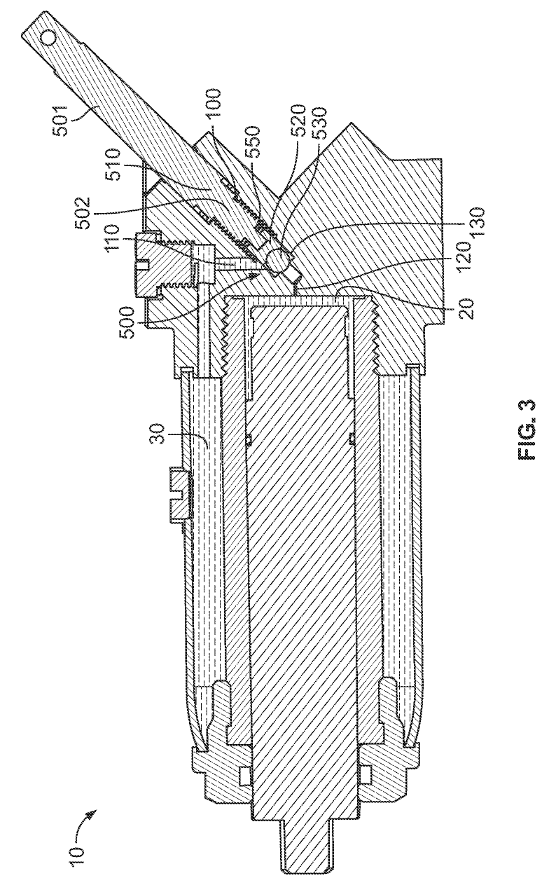

FIG. 3 illustrates the descent valve 500 in a portion of the floor jack 10, according to embodiments. Particulars of descent valve 500 are depicted in FIGS. 10A-11B, and described in corresponding text. Other descent valves could be implemented, including descent valves, 200, 300, or 400. The descent valve 500 is in fluid communication with reservoir 30 via reservoir passage 110. The descent valve 500 is further in fluid communication with cylinder 20 via cylinder passage 120. The descent valve 500 is located in the valve chamber 130 and includes a descent valve screw 510, piston head 520, descent valve poppet 530, and descent valve washers 550. The descent valve 500 selectively allows fluid to flow from cylinder 20 to reservoir 30. Handle 14 is coupled to descent valve screw 510 near the handle portion 501 to rotate the descent valve screw 510 in different directions to selectively cause the descent valve 500 to allow fluid to flow from cylinder 20 to reservoir 30.

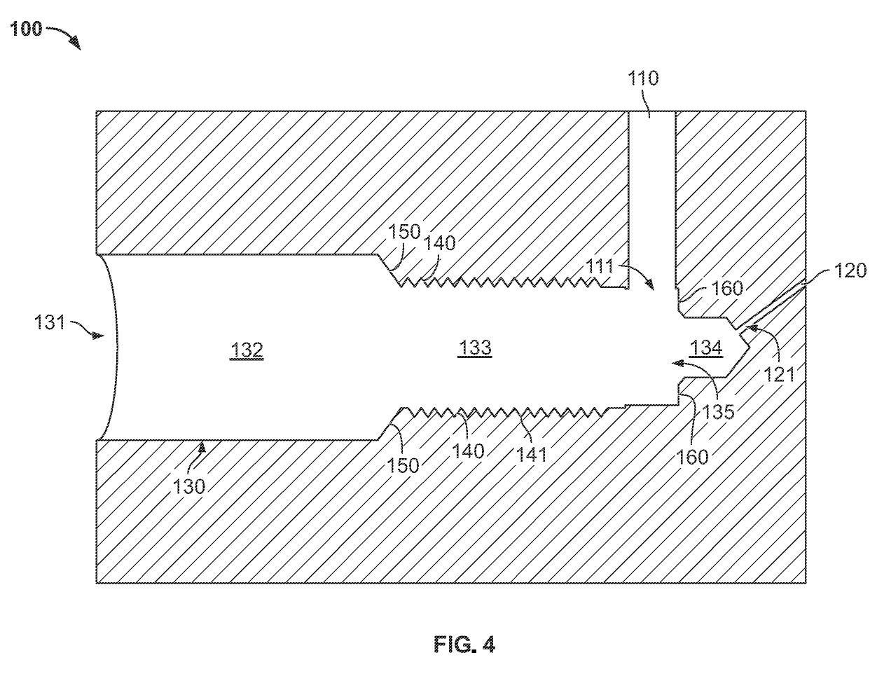

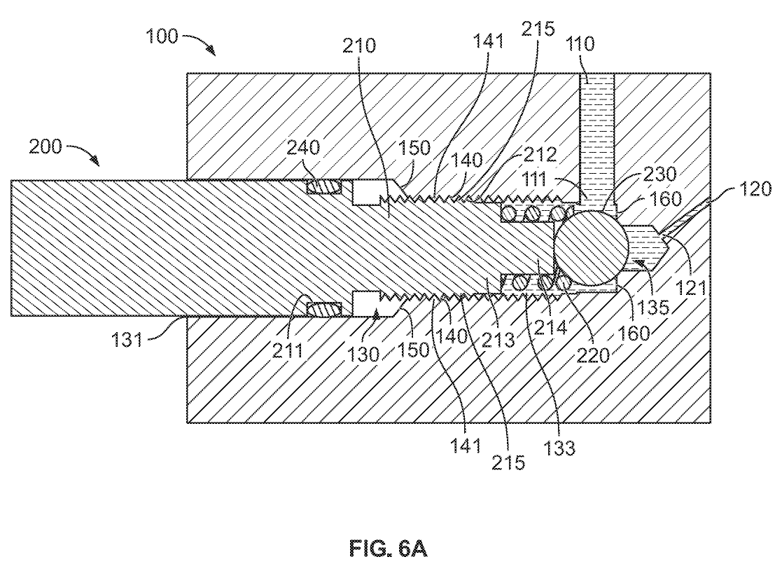

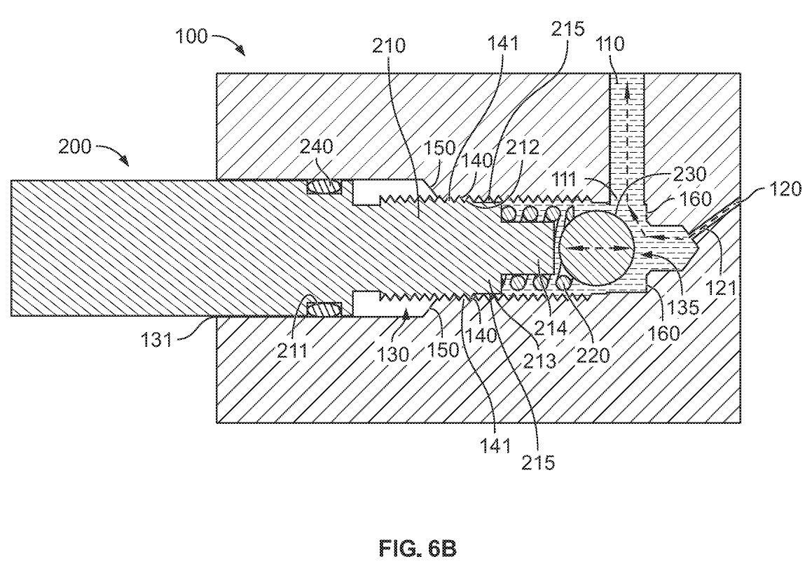

FIG. 4 illustrates a release valve port 100 in the floor jack 10. The release valve port 100 is a portion of the floor jack 10. The release valve port 100 may be formed from a material such as a ferrous or nonferrous material. The release valve port 100 may be formed via casting and/or may be machined. The release valve port 100 includes the reservoir passage 110, the reservoir passage orifice 111, the cylinder passage 120, the cylinder passage orifice 121, the valve chamber 130, a valve chamber orifice 131, a first region 132 in the valve chamber 130, a second region 133 in the valve chamber 130, a third region 134 in the valve chamber 130, an orifice 135 between the second region 133 and the third region 134 of the valve chamber 130, a coupling region 140, a first shoulder 150, and a second shoulder 160. The valve chamber orifice 131 may receive the portion of one of the descent valves 200, 300, 400, or 500 into the valve chamber 130, such as the chamber portion 502, see FIG. 3. The coupling region 140 may couple with one of the descent valves 200, 300, 400, or 500, and may include a plurality of threads 141 that couple with a plurality of complimentary threads 215, 315, 415, 515 associated with one of the descent valves 200, 300, 400, or 500, see FIG. 6A.

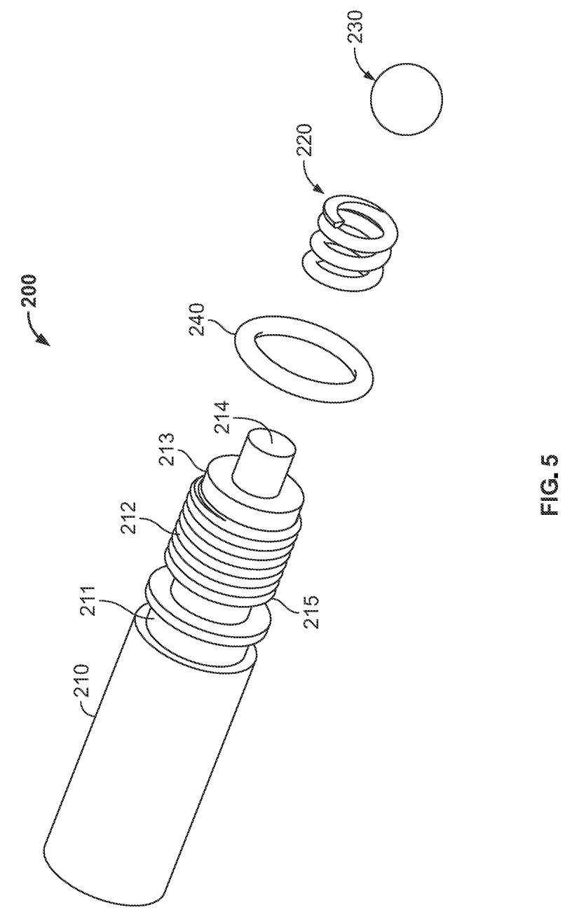

FIG. 5 illustrates an exploded view of the descent valve 200 for the floor jack 10, according to embodiments. While the descent valve 200 is disclosed herein as being a descent valve, aspects may be applicable to other types of valves, such as release valves. The descent valve 200 may include a screw 210, a screw recess 211, a coupling region 212, a screw shoulder 213, a screw post 214, a spring 220, a poppet 230, and an O-ring 240. The screw 210 may be tightened, thereby forcing the screw 210 forwardly, longitudinally, towards the cylinder 20. Similarly, the screw 210 may be loosened, thereby forcing the screw 210 backwardly, longitudinally, away from the cylinder 20. The operator can cause such forward and backward movement of the screw 210 via the handle 14 on the floor jack 10. While the screw 210 is disclosed, a similar mechanism could be implemented with a component, such as an axial push-pull valve, actuated by the handle 14, lever, foot pedal, or the like, where the operator can cause such a component to move forwardly or backwardly along the longitudinal dimension. Embodiments using the screw 210 may not use the handle 14 as an actuator. According to alternative embodiments, a separate knob or screw (or screw 210 itself) may be used as the actuator.

The screw 210 may include the recess 211 that receives the O-ring 240. The screw 210 may further include the coupling region 212, such as the threads 215. The threads 215 located on the coupling region 212 engage with the threads 141 located on the coupling region 140 of the release valve port 100. The screw 210 may be rotated, thereby causing longitudinal movement of the screw 210 with respect to the release valve port 100 due to the arrangement of the threads 141 in the coupling region 140 and the complimentary threads 215 in coupling region 212. The screw 210 may be rigid and not substantially compressible.

Referring to FIG. 5, the spring 220 may be a coil spring. The spring 220 of the descent valve 200 may be situated between the shoulder 213 of the screw 210 (e.g., abutting the shoulder 213) and the poppet 230 (e.g., abutting the poppet 230). The screw post 214 of the screw 210 may be situated at least partially within an interior region of the spring 220. While the poppet 230 is depicted as a sphere, other shapes are possible, such as a hemisphere, or cone.

Referring to FIG. 6A, the O-ring 240 may seal the valve chamber 130, such that fluid does not flow outwardly through the valve chamber orifice 131. The O-ring 240 may provide some friction against unintended rotation of the screw 210 when the descent valve 200 is in an open position. The O-ring 240 may keep the threads 215 of the coupling region 212 and the threads 141 of the coupling region 140 substantially clean and lubricated. In alternative embodiments, the dimensions and configurations of the release valve port 100 and the descent valve 200 may differ such that the coupling region 212 may be located outboard relative to the O-ring 240.

FIG. 6A illustrates a cross-sectional view of the descent valve 200 in the release valve port 100 in the floor jack 10 in a shutoff mode, according to embodiments. In the shutoff mode, the screw 210 has been advanced forwardly such that the post 214 of the screw 210 forces a portion of the poppet 230 into the orifice 135 in the valve chamber 130, thereby substantially sealing the orifice 135 prohibiting fluid to flow between the second region 133 and the third region 134 of the valve chamber 130. In this configuration, the post 214 of the screw 210 may directly about the poppet 230, keeping the poppet 230 in the shutoff mode. In the shutoff mode, the poppet 230 is in position to seal the orifice 135. When the orifice 135 is sealed, the cylinder passage 120 is not in fluid communication with the reservoir passage 110. In the depicted embodiment, by sealing the orifice 135, the third region 134 of the valve chamber 130 is no longer in fluid communication with the second region 133 of the valve chamber 130. As the cylinder passage 120 extends to the third region 134 of the valve chamber 130, and as the reservoir passage 110 extends to the second region 133 of the valve chamber 130, by isolating the second region 133 from the third region 134, the cylinder passage 120 is no longer in fluid communication with the reservoir passage 110. This arrangement is the shutoff mode, in which fluid cannot flow between the cylinder 20 via the cylinder passage 120 and the reservoir 30 via the reservoir passage 110 of the floor jack 10. The shutoff mode may be selected by the operator of the floor jack 10 to either lift the load or to maintain the position of the load at a given height. The shutoff mode may be elected by the operator by turning the handle 14 until the screw 210 is inserted into the valve chamber 130 and the threads 215 are fully or substantially engaged with the threads 141. In the preferred embodiment, the screw 210 may be fully inserted into the valve chamber 130 so all of the threads 215 located on the screw 210 are fully engaged with the threads 141 located on the coupling region 140 of the valve chamber 130. In alternative embodiments, the screw 210 may only be partially inserted into the valve chamber 130 in which a portion of the threads 215 located on the screw 210 are partially engaged with the threads 141 located on the coupling region 140 of the valve chamber 130. In alternative embodiments, there could be an actuator separate from the handle 14 (e.g., a knob or other screw) that causes the screw 210 to be inserted and/or removed into/from the valve chamber 130.

FIG. 6B illustrates a cross-sectional view of the descent valve 200 in the release valve port 100 in the floor jack 10 in a metering mode, according to embodiments. FIG. 6B is similar to FIG. 6A, except that the screw 210 has been backed off longitudinally in the valve chamber 130, thereby allowing fluid flow between the cylinder passage 120 and the reservoir passage 110. The longitudinal position of the poppet 230 within the valve chamber 130 may vary depending on the compression of the spring 220, the axial position of the screw 210, and/or the pressure of the fluid flow from the cylinder passage 120 to the reservoir passage 110. The spring 220 may be configured to regulate the positioning of the poppet 230 with respect to the orifice 135 in the metering mode. As the pressure of the fluid flow increases from the cylinder passage 120, the poppet 230 is forced backwardly towards the chamber orifice 131. The spring 220 becomes compressed, thereby exerting a force on the poppet 230 that opposes the force of the fluid on the poppet 230. As the spring 220 becomes more compressed, the force that the spring 220 puts on the poppet 230 increases. This push-back from the spring 220 tends to stabilize the position of the poppet 230 when fluid pressure varies. The spring 220 may keep the poppet 230 in contact with a portion of the screw post 214 within the valve chamber 130 with partial or full shut off, when the screw 210 is initially loosened or subsequently. As the descent valve 200 is further loosened there is less engagement between the threads 141 of the coupling region 140 and the threads 215 on the screw 210, some or more fluid is allowed to flow more gradually relative to screw 210 position. The constant K of the spring 220 may be high enough to provide a full or partial shut off when the screw 210 is initially loosened. The thread pitch or axial travel of the screw 210, and the constant K of the spring 220 may both be factors. If K is too low, the fluid pressure may overly compress the spring 220 and limit its effectiveness. As K approaches being rigid, the assembly would act similar to a non-spring configuration. As the position of the poppet 230 tends to stabilize, so too does the rate of fluid flow between the cylinder passage 120 and the reservoir passage 110.

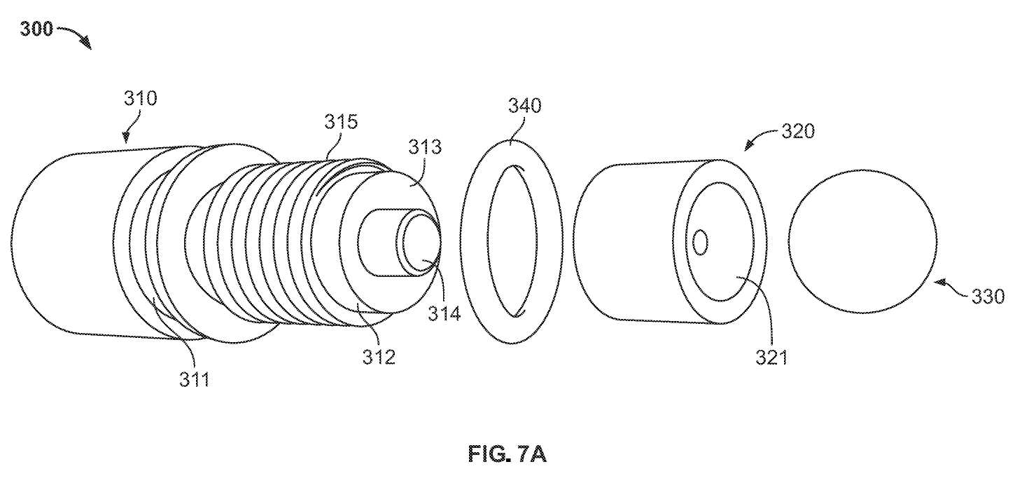

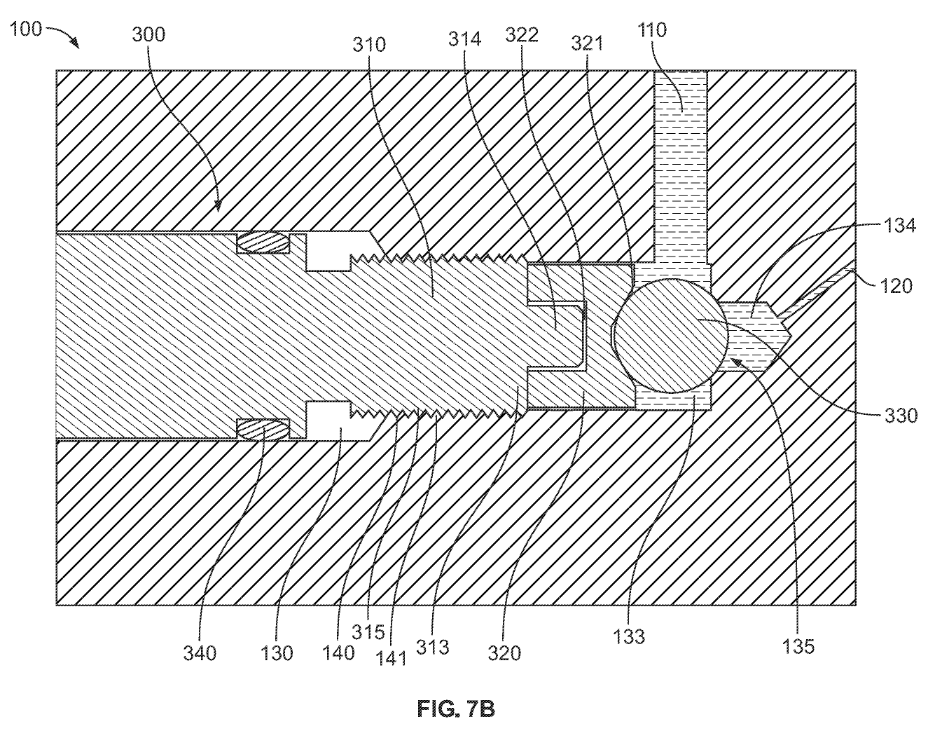

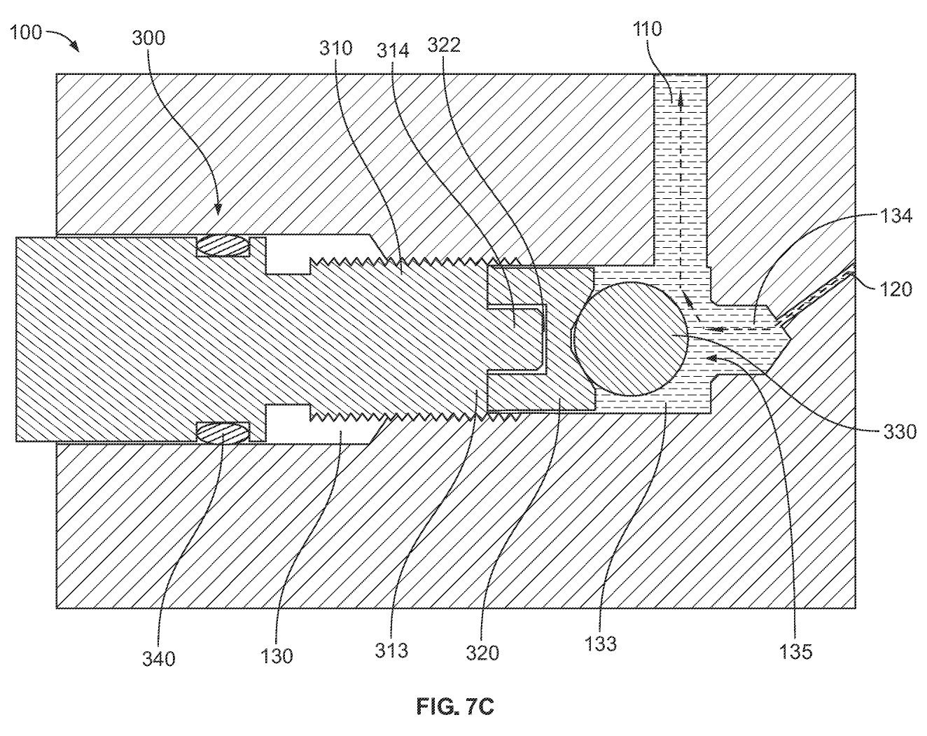

FIG. 7A illustrates an exploded view of an alternative embodiment of a descent valve 300 for the floor jack 10, according to embodiments. The descent valve 300 is similar to the descent valve 200, in that the descent valve 300 operates in a shutoff mode to stop fluid flow between the cylinder passage 120 and the reservoir passage 110, and in a metering mode to substantially regulate the fluid flow between the cylinder passage 120 and the reservoir passage 110. However, some aspects of the structure of the descent valve 300 differ from those of the descent valve 200.

Referring to FIG. 7A, the descent valve 300 may include a screw 310, a head 320, and a poppet 330. The head 320 is separate from the screw 310. The screw 310 may include a screw recess 311, a coupling region 312 including threads 315, a screw shoulder 313, a screw post 314, and an O-ring 340. The screw 310, the poppet 330, and the O-ring 340 may have similar structures and functions as the screw 210, the poppet 230, and the O-ring 240, except as explained otherwise.

Referring to FIG. 7A and FIG. 7B, the head 320 includes a front recess 321 and a rear recess 322. The poppet 330 may be received by the front recess 321 of the head 320. The front recess 321 of the head 320 may have different geometries, such as a concave hemispherical shape. The shape of the front recess 321 may be selected to tend to center the poppet 330 when transitioning from the metering mode to the shutoff mode (further disclosed below in conjunction with FIGS. 7B and 7C). The front recess 321 is shaped to limit the amount of stress either the poppet 330 or the head 320 may experience when the head 320 and the poppet 330 may come into contact with each other. Furthermore, it is important to not over-constrain the poppet 330 and prevent it from seating improperly on the front recess 321 of the head 320. Therefore, the front recess 321 is configured to limit the poppet 330 from being seated or contacting the front recess 321 of the head 320 improperly. Additionally, the front recess 321 is shaped to receive portions of the poppet 330 even if the portions of the screw 310 may become misaligned throughout the life of the floor jack 10. The screw post 314 may be received by the rear recess 322 of the head 320. The radial clearance between the screw post 314 and the rear recess 322 may vary. Exemplary radial clearances may be between about 0.003” to 0.005”. Such a radial clearance may prevent over-constraining the position of the poppet 330 in the shutoff mode. Over constraint may force the poppet 330 off the center axis, possibly causing leakage or damage. The head 320 may be rigid and substantially not compressible.

The head 320 may abut the screw shoulder 313, thereby causing a clearance between portions of the screw post 314 and the rear recess 322 of the head 320. Thus, all surfaces of the rear recess 322 may have clearance from the screw post 314. In this manner, the degree of possible movement of the head 320 during metering mode may allow the head 320 to move such that its radial location is not determined solely by the position of the screw 310 of the descent valve 300.

FIG. 7B illustrates a cross-sectional view of the descent valve 300 in the release valve port 100 in the floor jack 10 in a shutoff mode, according to embodiments. When the screw 310 is inserted into the valve chamber 130, the screw shoulder 313 abuts the head 320, the screw 310 forces the poppet 330 via the head 320 to seal the orifice 135 between the second region 133 and the third region 134 of the valve chamber 130. The front recess 321 of the head 320 receives the poppet 330. The shutoff mode may be elected by the operator by turning the handle 14 until the descent valve 300 is inserted into the valve chamber 130 and the threads 315 are fully or substantially engaged with the threads 141. In the preferred embodiment, the descent valve 300 may be fully inserted into the valve chamber 130 so the majority of the threads 315 located on the screw 310 are fully engaged with the threads 141 located on the coupling region 140 of the valve chamber 130. In alternative embodiments, the descent valve 300 may only be partially inserted into the valve chamber 130 in which less threads 315 located on the screw 310 are engaged with threads 141 located on the coupling region than when the descent valve 300 is fully inserted into the valve chamber 130. In alternative embodiments, there could be an actuator separate from the handle 14 (e.g., a knob or other screw) that causes the descent valve 300 to be inserted and/or removed into/from the valve chamber 130.

The descent valve 300 may address an issue where the threads 141 in the coupling region 140 of the release valve port 100, the coupling region 312 (including the threads 315) of the screw 310, and the front recess 321 of the head 320 are not being perfectly concentric. This may lead to the poppet 330 being forced off part of the orifice 135 between the second region 133 and the third region 134 of the valve chamber 130, or increased contact stress on portions of the release valve port 100 proximate the orifice 135. Another issue is the potential for deformation on a portion of the post 314 of the screw 310 from contact stress of loading against the poppet 330 (which may be harder than the screw 310). The front recess 321 in the head 320 that receives the poppet 330 may reduce such contact stress compared to having a poppet 330 contacting a portion of the post 314 (e.g., flat surface) of the screw 310 directly. Another potential solution to this issue may be achieved using a different geometry such as the head 320 in a smooth section of the valve chamber 130, rather than in a section of the valve chamber 130 with threads 141.

FIG. 7C illustrates a cross-sectional view of the descent valve 300 in the release valve port 100 in the floor jack 10 in the metering mode, according to embodiments. As the screw 310 is loosened, the head 320 reduces the force on the poppet 330 until fluid begins to flow around the poppet 330 from the cylinder passage 120 to the reservoir passage 110. The clearance between the post 314 of the screw 310 and the rear recess 322 of the head 320 may enable the poppet 330 to seat properly within the front recess 321 of the head 320 (e.g., substantially constraining the radial position of the poppet 330 with respect to a center axis), without the potential over-constraining result of putting the poppet 330 directly on a portion of the screw post 314.

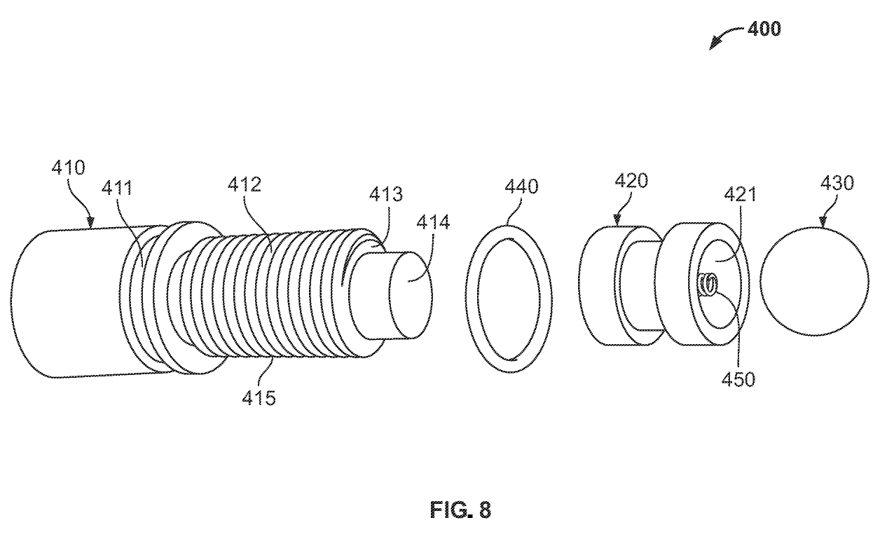

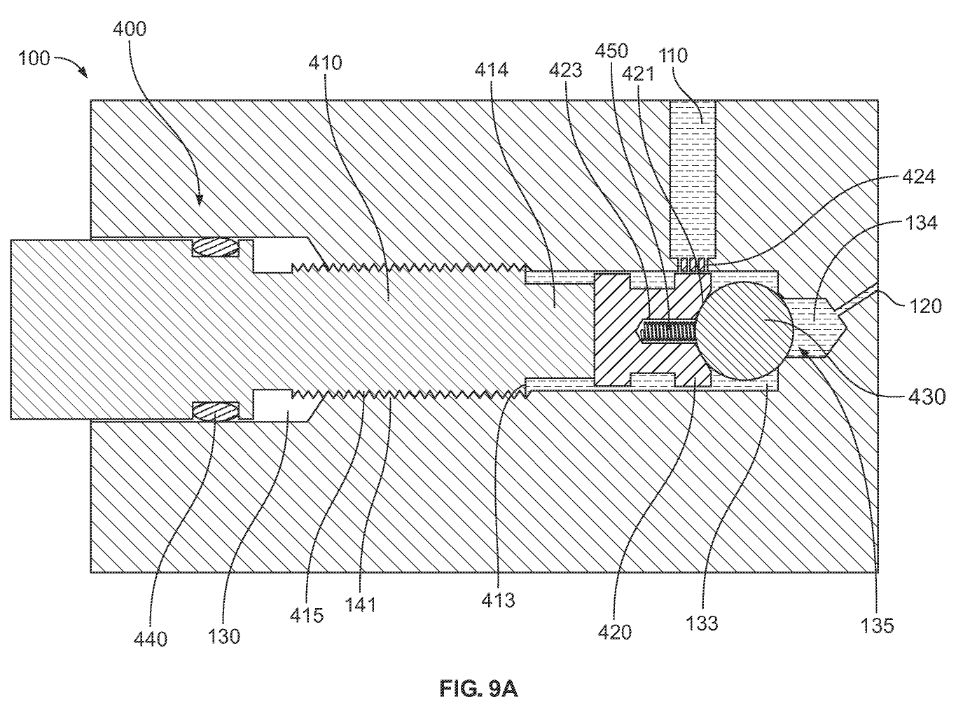

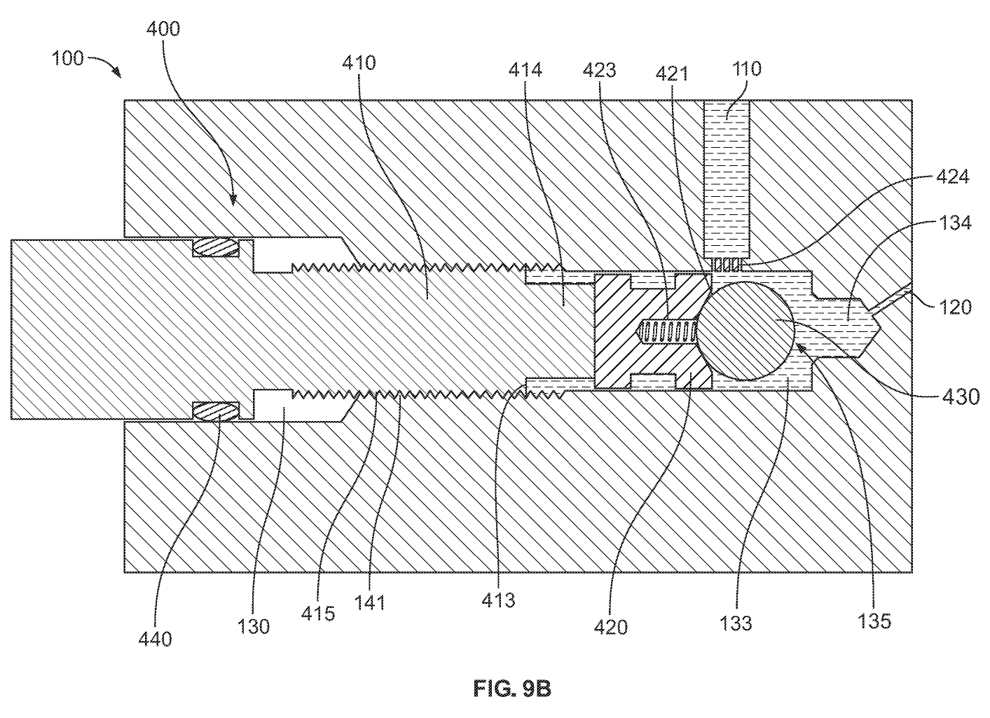

FIG. 8 illustrates an exploded view of the descent valve 400 for the floor jack 10, according to embodiments. The descent valve 400 may be similar to the descent valve 200 and/or 300, unless as disclosed otherwise. The descent valve 400 may include a screw 410, a screw recess 411, a coupling region 412 including threads 415, a screw shoulder 413, a screw post 414, a piston head 420, a poppet 430, and an O-ring 440. The screw 410, the poppet 430, and the O-ring 440 may have similar structures and functions as the screws 210, 310, the poppets 230, 330, and the O-rings 240, 340 except as explained otherwise. The piston head 420 includes a front recess 421 and a spring recess 423 (seen in FIGS. 9A and 9B). The piston head 420 may be similar to the piston head 320, except as disclosed otherwise.

Referring to FIG. 9A and FIG. 9B, the descent valve 400 may further include a spring 450 that is received by the spring recess 423 of the piston head 420 and interacts with the poppet 430. The spring 450 may have a similar function and operation as the spring 220 with respect to regulating the flow of fluid between the cylinder passage 120 and the reservoir passage 110. In the descent valve 400, the poppet 430 is primarily used to shut off fluid flow, and metering occurs by the location of the piston head 420 relative to a plurality of valve chamber passages 424 extending between the reservoir passage 110 and the second region 133 of the valve chamber 130. The spring 450 may cause contact to be maintained between the piston head 420 and the screw post 414 of the screw 410 as the screw 410 travels along the valve chamber 130. As the spring 450 is decompressed, the poppet 430 and the piston head 420 may no longer be in contact with each other or the poppet 430 may remain in contact with the piston head 420. The poppet 430 may move away from the third region 134 of the valve chamber 130, no longer creating a seal and permitting fluid to flow from the cylinder passage 120 towards the third region 134 of the valve chamber 130. The piston head 420 may travel towards the valve chamber orifice 131 and away from the third region 134 when the spring 450 becomes decompressed. As the piston head 420 travels towards the valve chamber orifice 131, portions of the piston head 420 move past the valve chamber passages 424. Once the piston head 420 moves beyond at least one of the valve chamber passages 424, fluid may begin flowing between the cylinder passage 120 and the reservoir passage 110. The more distance the piston head 420 travels towards the valve chamber orifice 131, the more valve chamber passages 424 are exposed may increase the flow rate of the fluid and may permit more fluid to flow between the cylinder passage 120 and the reservoir passage 110. By having more valve chamber passages 424 being exposed with greater travel from the piston head 420 may cause the fluid to flow between the cylinder passage 120 and the reservoir passage 110 at a greater rate than only having one or two valve chamber passages 424 exposed to permit fluid flow from the cylinder passage 120 to the reservoir passage 110. When the piston head 420 travels directionally towards the third region 134 of the valve chamber 130, the piston head 420 may block some of the valve chamber passages 424 or all of the valve chamber passages 424, thus decreasing the flow rate between the cylinder passage 120 and the reservoir passage 110 or prohibiting fluid flow between the cylinder passage 120 and the reservoir passage 110, respectively. The spring 450 is in a more compressed state in the piston head 420 when the fluid flow between the cylinder passage 120 and the reservoir passage 110 is limited or nonexistent. In the exemplary embodiment, there are four valve chamber passages 424 extending between the valve chamber 130 and the reservoir passage 110. In alternative embodiments, there may be more than four or less than four valve chamber passages 424 extending between the valve chamber 130 and the reservoir passage 110.

FIG. 9A illustrates a cross-sectional view of the descent valve 400 in the release valve port 100 in the floor jack 10 in a shutoff mode, according to embodiments. When the screw 410 is inserted into the valve chamber 130, the screw post 414 abuts the piston head 420, the screw 410 forces the poppet 430 via the piston head 420 to seal the orifice 135 between the second region 133 and the third region 134 of the valve chamber 130. The piston head 420 includes the front recess 421 that receives the poppet 430. In the shutoff mode, the spring 450 is compressed in the spring recess 423 of the piston head 420. The benefit of the front recess 421 in the piston head 420 may be similar to the benefit of the front recess 321 in the piston head 320 of the descent valve 300 (e.g., better seating of the poppet 430 in the orifice 135 in the valve chamber 130 or less stress in regions of the release valve port 100 proximate to the orifice 135). The lack of a rear recess in the piston head 420 may be implemented in association with positioning the piston head 420 in a smooth section of the valve chamber 130, rather than in a section of the valve chamber 130 with threads. The shutoff mode may be elected by the operator by turning the handle 14 until the descent valve 400 is inserted into the valve chamber 130 and the threads 415 are fully or substantially engaged with the threads 141. In the preferred embodiment, the descent valve 400 may be fully inserted into the valve chamber 130 so the majority of the threads 415 located on the screw 410 are fully engaged with the threads 141 located on the coupling region 140 of the valve chamber 130. In alternative embodiments, the descent valve 400 may only be partially inserted into the valve chamber 130 in which less threads 415 located on the screw 410 are engaged with threads 141 located on the coupling region than when the descent valve 400 is fully inserted into the valve chamber 130. In alternative embodiments, there could be an actuator separate from the handle 14 (e.g., a knob or other screw) that causes the descent valve 400 to be inserted and/or removed into/from the valve chamber 130.

FIG. 9B illustrates a cross-sectional view of the descent valve 400 in the release valve port 100 in the floor jack 10 in a metering mode, according to embodiments. Under pressure, the screw 410, the piston head 420, and the poppet 430 may maintain contact with each other when the spring 450 is compressed. The operation of the descent valve 400 in the metering mode may be similar to the operation of the first descent valve 200 and/or the operation of the second descent valve 300.

FIG. 10A illustrates an exploded view of the descent valve 500 for the floor jack 10, according to embodiments. The descent valve 500 may include a screw 510, a screw recess 511, a coupling region 512, a screw shoulder 513, a screw post 514, a piston head 520, a poppet 530, and an O-ring 540. The screw 510, the piston head 520, the poppet 530, and the O-ring 540 may have similar structures and functions as the screw 210, 310, 410 the piston head 220, 320, 420, the poppet 230, 330, 430, and the O-ring 240, 340, 440 of the descent valves 200, 300, 400. The descent valve 500 further includes a plurality of washers 550 (washers 550a-d), which act as a spring. Another type of compressible component (e.g., a coil spring) may be substituted or used in conjunction with the washers 550. The washers 550 may be interposed between the screw shoulder 513 and the piston head 520, encircling the screw post 514. The washers 550 may be spring washers, such as Belleville washers. The washers 550 each have a convexity and a concavity. At least two adjacent washers 550 (e.g., washers 550b and 550c) may have opposing convexities and/or concavities. In alternative embodiments, the washers 550 may only include a single washer 550, in which case the single washer 550 acts as a spring. The washers 550 may flatten out under pressure.

Referring to FIG. 10B, an exploded view of the washers 550 is shown. There are four individual washers 550a, 550b, 550c, and 550d, although a fewer number (e.g., one or two) or a greater number (e.g., six) of individual washers 550 may be possible. The washer 550a has a concavity facing in one direction, such as to the right. Washer 550b also has a concavity facing in one direction, such as to the right. Washer 550c has a concavity facing in one direction, such as to the left. Washer 550d also has a concavity facing in one direction, such as to the left. Other arrangements are possible, with the concavities of the washers 550 facing as such: washer 550a (right); washer 550b (left); washer 550c (right); and washer 550d (left). Where the concavities of adjacent individual washers 550 are facing each other, each of these individual washers 550 are capable of compressing and decompressing, thereby acting as a spring.

FIG. 11A illustrates a cross-sectional view of the descent valve 500 in the release valve port 100 in the floor jack 10 in a shutoff mode, according to embodiments. The operation of the descent valve 500 in the shutoff mode is similar to that of the descent valves 200, 300, and 400. When the screw 510 is advanced into the valve chamber 130, washers 550 are compressed and exert a force on the piston head 520 and/or the screw shoulder 513. The screw post 514 may contact the base of the piston head 520, before the washers 550 are flattened. In an uncompressed state, the free height of the washers 550 causes the washers 550 to contact the screw shoulder 513 and the piston head 520, and the screw post 514 may not touch the piston head 520. In a partially compressed metering mode, the washers 550 may be partially compressed but may otherwise function as described above. The poppet 530 may be pushed off the seat of the orifice 135 with sufficient fluid pressure. In the shut off state, the washers 550 may function as described above, but the washers 550 may be further compressed. The screw post 514 may be in contact with the piston head 520. This effectively may take the washers 550 out of the series, with a direct connection from the screw post 514 to the piston head 520, to poppet 530, to the seat of the orifice 135. The poppet 530 may not be pushed off the seat. The piston head 520, in turn, exerts a force on the poppet 530, which then seals the orifice 135 in the valve chamber 130, thereby stopping the flow of fluid from the cylinder passage 120 to the reservoir passage 110. The shutoff mode may be elected by the operator by turning the handle 14 until the descent valve 500 is inserted into the valve chamber 130 and the threads 515 are fully or substantially engaged with the threads 141. In the preferred embodiment, the descent valve 500 may be fully inserted into the valve chamber 130 so the majority of the threads 515 located on the screw 510 are fully engaged with the threads 141 located on the coupling region 140 of the valve chamber 130. In alternative embodiments, the descent valve 500 may only be partially inserted into the valve chamber 130 in which less threads 515 located on the screw 510 are engaged with threads 141 located on the coupling region than when the descent valve 500 is fully inserted into the valve chamber 130. In alternative embodiments, there could be an actuator separate from the handle 14 (e.g., a knob or other screw) that causes the descent valve 500 to be inserted and/or removed into/from the valve chamber 130.

FIG. 11B illustrates a cross-sectional view of the descent valve 500 in the release valve port 100 in the floor jack 10 in a metering mode, according to embodiments. The operation of the descent valve 500 in the metering mode is similar to that of the descent valves 200, 300, and 400. When the screw 510 is backed out of the valve chamber 130, the washers 550 decompress at least partially. The poppet 530 is no longer seated in the orifice 135, and fluid flows between the cylinder passage 120 and the reservoir passage 110. The washers 550 act as a spring and regulate the flow of the fluid between the cylinder passage 120 and the reservoir passage 110 by moving the poppet 530 forwards and backwards according to the degree of compression of the washers 550. As the spring force of the washers 550 reduces to an amount less than the opposing fluid pressure on the opposite side of the poppet 530, fluid begins to flow around the poppet from the cylinder passage 120 to the reservoir passage 110 to allow the load supported by the floor jack 10 to lower. In an exemplary embodiment, a total unloading of the springs may occur in approximately 1/8 of a turn of the handle 14. Belleville washers may be advantageous in this application because of their relatively high spring constant in a small package, where relatively larger displacement (e.g., displacement less than about 0.008”) is not needed. In alternative embodiments, other types of washers 550 may be used having spring-like characteristics, such as curved washers, finger washers, wave washers, split lock washers, helical spring lock washers, tooth lock washers, etc. Additionally, in alternative embodiments, washers 550 may be used not having spring-like characteristics.

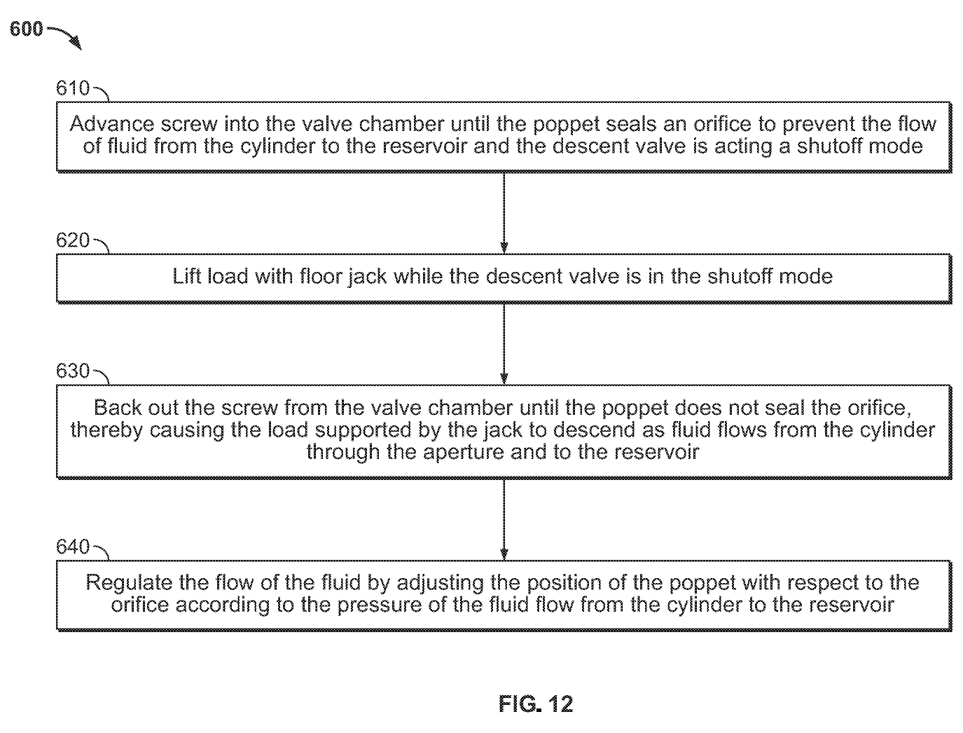

FIG. 12 is a flowchart 600 for a method of operation of a descent valve in the floor jack 10, according to embodiments. The flowchart 600 and method embodiments are described with respect to the descent valve 200 of the jack 10, but is applicable to the descent valves 300, 400, and 500, or other suitable descent valves.

At step 610, the screw 210 is advanced into the valve chamber 130 until the poppet 230 seals the orifice 135 in the valve chamber 130 to prevent the flow of fluid from the cylinder 20 (e.g., via the cylinder passage 120) to the reservoir 30 (e.g., via the reservoir passage 110), and the descent valve 200 operates in a shutoff mode. The screw 210 may be advanced into the valve chamber 130 via the handle 14. The operator of the floor jack 10 may engage with rotating the handle 14, which then causes the screw 210 to turn (e.g., turn clockwise) to advance the screw 210 into the valve chamber 130.

At step 620, while the descent valve 200 operates in the shutoff mode, the operator may engage with the floor jack 10, for example, by repeatedly stroking or pumping the handle 14 by repeatedly moving the handle 14 about the handle pivot 19 to cause fluid to flow from the pump 21 to the cylinder 20. In such a way, a load supported by the floor jack 10 may be lifted upwardly.

At step 630, the operator of the floor jack 10 may desire to lower the load supported by the floor jack 10. The operator may cause the screw 210 to be backed out of the valve chamber 130 until the poppet 230 does not seal the orifice 135 in the valve chamber 130. Fluid may then flow from the cylinder 20 (via the cylinder passage 120), through the orifice 135 in the valve chamber 130, and to the reservoir 30 (via the reservoir passage 110). As the fluid flows from the cylinder 20 to the reservoir 30, the load descends. The operator may back out the screw 210 from the valve chamber 130 by engaging in the handle 14 (e.g., rotating the handle 14 in a direction).

At step 640, while fluid is flowing from the cylinder 20 to the reservoir 30, the rate of the flow of the fluid is regulated by adjusting the position of the poppet 230 with respect to the orifice 135 in the valve chamber 130. The poppet 230 tends to remain in a constant location with respect to the orifice 135 due to the opposing forces on the poppet 230 caused by the fluid flow and the spring 220. In this manner, the descent valve 200 operates in a metering mode. At any time during descent, the operator may place the descent valve 200 back into the shutoff mode. Further, the operator may adjust the rate of the flow of fluid by changing the position of the screw 210. For example, the operator may increase the rate of the flow of the fluid by backing the screw 210 out further from the valve chamber 130, away from the third region 134 of the valve chamber 130, thereby increasing the speed of the descent of the load. Similarly, the operator may decrease the rate of the flow of the fluid by advancing the screw 210 further into the valve chamber 130, towards the third region 134 of the valve chamber 130, thereby decreasing the speed of the descent of the load.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A valve in a lifting device, wherein the valve is configured to operate in a metering mode and in a shutoff mode to control fluid through an orifice, the valve comprising:
a poppet;
a first portion configured to move in a first direction forcing the poppet to seal the orifice in the shutoff mode, and further configured to move in a second direction releasing the poppet from the orifice in the metering mode; and
a second portion configured to regulate positioning of the poppet with respect to the orifice in the metering mode.

2. The valve of claim 1, wherein the first portion is not compressible, and wherein the second portion is compressible.

3. The valve of claim 1, wherein a flow rate of the fluid is adjustable corresponding to an adjustable position of the first portion.

4. The valve of claim 1, wherein the first portion comprises a screw.

5. The valve of claim 1, wherein the first portion comprises a piston head.

6. The valve of claim 1, wherein the second portion comprises a spring.

7. The valve of claim 6, wherein the spring comprises a plurality of spring washers.

8. A lifting device, comprising:
a cylinder configured to retain a fluid;
a reservoir configured to receive fluid from the cylinder; and
a valve configured to control the fluid flowing from the cylinder to the reservoir through an orifice, the valve comprising:
a poppet;
a first portion configured to move in a first direction forcing the poppet to seal the orifice in a shutoff mode, and further configured to move in a second direction releasing the poppet from the orifice in a metering mode; and
a second portion configured to regulate positioning of the poppet with respect to the orifice in the metering mode.

9. The lifting device of claim 8, wherein the first portion is not compressible, and wherein the second portion is compressible.

10. The lifting device of claim 8, wherein a flow rate of the fluid is adjustable corresponding to an adjustable position of the first portion.

11. The lifting device of claim 8, wherein the first portion comprises a screw.

12. The lifting device of claim 8, wherein the first portion comprises a piston head.

13. The lifting device of claim 8, wherein the second portion comprises a spring.

14. The lifting device of claim 8, wherein the second portion comprises at least one spring washer.

15. The lifting device of claim 13, wherein the spring comprises a plurality of spring washers.

16. A lifting device for supporting an object, the lifting device comprising:
a lifting arm configured to receive a load;
a valve chamber configured to receive a valve;
a cylinder configured to retain a fluid;
a reservoir configured to receive the fluid from the cylinder;
a cylinder passage extending between the cylinder and the valve chamber;
a reservoir passage extending from the reservoir; and
a plurality of valve chamber passages located between the valve chamber and the reservoir passage,
wherein the valve controls the fluid flowing from the cylinder passage to the plurality of valve chamber passages.

17. The lifting device of claim 16, wherein the valve operates in at least two modes, a shutoff mode and a metering mode.

18. The lifting device of claim 17, wherein the valve blocks all of the valve chamber passages in the shutoff mode to prevent fluid from flowing from the cylinder to the reservoir.

19. The lifting device of claim 16, wherein the valve is positioned to permit fluid to flow from the cylinder to the reservoir through at least one of the valve chamber passages in the metering mode.

20. The lifting device of claim 19, wherein a flow rate of the fluid is adjustable dependent on the position of the valve and the number of valve chamber passages open to permit fluid to flow from the cylinder to the reservoir, the more valve chamber passages permitting fluid to flow from the cylinder to the reservoir increases the flow rate of the fluid, and the fewer valve chamber passages permitting fluid to flow from the cylinder to the reservoir decreases the flow rate.
